(19) United States
(12) Patent Application Publication
(10) Pub. No.: US 2004/0203873 A1
(43) Pub. Date: Oct. 14, 2004

(54) Method and system of informing WAN user of nearby WLAN access point

(76) Inventor: William H. Gray, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/247,084

(22) Filed: Sep. 19, 2002

(51) Int. Cl. H04Q 7/20; H04L 12/28

(52) U.S. Cl. 455/456.1; 455/427; 370/901; 455/435.1

(57) ABSTRACT

A system and method of informing a WAN user of nearby WLAN access points, comprising determining a current position of a mobile appliance associated with the WAN user, transmitting the current position of said mobile appliance to a WAN service provider over a WAN network, determining the location of one or more WLAN access points that are accessible to the WAN user from the current position of the mobile appliance to provide a WLAN location information; and transmitting the WLAN location information to the mobile device over the WAN network, thereby enabling the WAN user to access and utilize a WLAN network.

### CROSS-REFERENCE TO RELATED APPLICATIONS

This application is related to a co-pending application entitled “Method and System for Providing Bandwidth on Demand to WAN User from WLAN Access Point,” Ser. No. ______ [attorney docket number 100111016-1], filed concurrently herewith, the disclosure of which is incorporated herein in its entirety.

### FIELD OF THE INVENTION

The present invention relates generally to communications system, and in particular to a method and system for informing a Wide Area Network (WAN) user of nearby, accessible Wireless Local Area Network (WLAN) access points.

### BACKGROUND OF THE INVENTION

A WAN cellular communication or wireless telecommunication network system includes a number of fixed base stations (also known as cell sites) often interconnected by a cable medium to a Mobile Switching Center (MSC) that connects to the Public Switched Telephone Network (PSTN). The PSTN is often referred to as the system backbone.

Associated with each base station is a geographic cell. The cell is a geographic coverage area in which a base station has sufficient signal strength to transmit data and receive data from a mobile appliances, such as a data terminal, Personal Digital Assistant (PDA), pager or telephone, with an acceptable error rate. Typically, base stations are positioned such that the combined cell area coverage from each base stations provides full coverage of a particular area or zone.

Mobile appliances such as telephone, pagers, PDAs, email devices, data terminals etc. are designed to move throughout the system from cell to cell with the wireless subscriber. Each mobile appliance is capable of communicating with the system backbone via wireless communication between the mobile device and a base station to which the mobile appliance is registered. As the wireless subscriber roams from one cell to another, the mobile appliance associated with a wireless subscriber will typically deregister with the base station of the previous cell and register with the base station associated with the new cell.

WANs can be co-located with other telecommunication networks, such as WLANs. Local Area Networks (LANs) are typically connected by routers and bridges and users typically connect their mobile appliances, such as notebook computers or PDAs, via a wireless IEEE 802.11 access point. Routers and bridges differ in that routers operate at the network layer level of the International Standards Organization (ISO) Open Systems Interconnection (OSI) reference model, and bridges operate at the data link layer of the OSI reference model. Currently available IEEE 802.11 access points utilize the 802.11b (11 Mbps data rate) or 802.11a (54 Mbps data rate) standards. For geographically dispersed WLANs, the LANs can be interconnected by use of the Public Switched Telephone Network (PSTN), Public Switched Data Network (PSDN), Integrated Services Digital Network (ISDN), and the Internet and the like.

Although the generally available data transmission rates of the WAN are adequate to support many current wireless voice and data services, such as email, cellular calls and the like, it is not suitable for transmitting, receiving, uploading or downloading a video file or a large data file such as an attachment to an email. A typical WAN cell site covers a few kilometers while a typical IEEE 802.11b WLAN access point covers about 100 meters. Therefore, a user may be within range of a WAN base station yet out of range of the higher data rate WLAN access point. Additionally, the WAN user connected to a WAN network is generally unaware of and/or can't locate nearby access points to access and utilize a high bandwidth transmission system, such as a WLAN-based network.

Accordingly, the present invention proceeds upon the desirability of informing a WAN user of nearby WLAN access points or sites, thereby enabling the WAN user to access and utilize the high bandwidth WLAN-based network to efficiently and quickly transmit, receive, upload or download a video file or a large data file.

### BRIEF SUMMARY OF THE INVENTION

A method of informing a WAN user of nearby WLAN access points, comprising the steps of determining a current position of a mobile appliance associated with the WAN user, transmitting the current position of said mobile appliance to a WAN service provider over a WAN network, determining the location of one or more WLAN access points that are accessible to the WAN user from the current position of the mobile appliance to provide a WLAN location information; and transmitting the WLAN location information to the mobile device associated with the WAN user over the WAN network, thereby enabling the WAN user to access and utilize a WLAN network.

A system for informing a WAN user of nearby WLAN access points that comprises a WAN network having a plurality of cell sites and at least one position location server, a plurality of WLAN access points in communication with a WLAN network, a mobile appliance associated with the WAN user and in communication with a serving cell site, the serving cell site being one of the cell sites, and means for determining a current position of the mobile appliance associated with the WAN user. The serving site is operable to transmit the current position of the mobile appliance to the position location server over the WAN network. The position location server is operable to determine the location of one or more WLAN access points that are accessible to the WAN user from his/her current position to provide a WLAN location information and to transmit the WLAN location information to the mobile device associated with the WAN user over the WAN network and the serving site, thereby enabling the WAN user to locate, access and utilize the WLAN network.

### BRIEF DESCRIPTION OF THE DRAWINGS

For a more complete understanding of the present invention, reference is now made to the following descriptions taken in conjunction with the accompanying drawings, in which:

FIG. 1 illustrates an example of wireless telecommunications network system incorporating a WAN;

FIG. 2 illustrates an example of wireless telecommunications network system incorporating a WLAN;

FIG. 3 illustrates an exemplary process of registering a cell phone to a mobile switching center;

FIG. 4 illustrates an exemplary process of delivering calls to a WAN user roaming in the cellular communications system;

FIG. 5 illustrates a method of informing a WAN user of nearby WLAN access points in accordance with an embodiment of the present invention; and

FIG. 6 is a schematic representation of WLAN enabled mobile appliance in accordance with an aspect of the present invention.

### DETAILED DESCRIPTION OF THE INVENTION

Wireless Local Area Networks have been developed and are now used in offices, retail stores and large industrial facilities. WLANs provide data communication between computers, printers, servers and other devices without the trouble and expense of installing wires and cables. In addition to data communication, WLANs can provide voice communication between appliances on the WLAN.

The IEEE 802.11 standard is a standard for WLANs and represents a family of specifications developed by IEEE for systems that operate in the 2.4 GHz Industrial, Scientific and Medical (ISM) band and the 5.0 GHz Unlicensed National Information Infrastructure (U-NII) band. The ISM band is available worldwide and allows unlicensed operation of spread spectrum systems. Portions of the 5.0 GHz UNII band are available worldwide with various country-specific regulatory limitations. The IEEE 802.11 RF transmissions use multiple signaling schemes (modulations) at different data rates to deliver a single data packet between wireless systems. The IEEE 802.11 wireless LAN uses a band of frequencies near 2.4 GHz to support data communication at up to 11 Mbps using Direct Sequence Spread Spectrum (DSSS) modulation. The 802.11a wireless LAN uses frequencies near 5.0 GHz to support data communication at rates up to 54 Mbps using Orthogonal Frequency Division Multiplexing (OFDM).

Turning now to FIG. 1, cellular communications or wireless telecommunications network system 10 comprises WAN or network backbone 12, which can be a hardwired data communication path made of twisted pair cable, shielded coaxial cable or fiber optic cable, for example, or may be wireless or partially wireless in nature. Coupled to WAN 12 is one or more fixed communication devices 17 and several access or cell sites 14. Although two access or cell sites 14 are shown hardwired to network backbone 12, it will be understood by those of skill in the art that one or several cell sites 14 can be coupled to network backbone 12 via a wired or wireless connection.

Each cell site 14 is capable of communicating wirelessly with mobile appliances 18, such as cell phones, pagers, Personal Digital Assistant (PDA), email devices (e.g., BLACKBERRY™) and the like, in wireless communication system 10 via respective antennas commonly denoted by reference numeral 16. A geographic cell (not shown) associated with each cell site 14 defines a region of coverage in which successful wireless communication may occur. Depending on the type of antenna 16 selected and output power of the respective cell site 14, the geographic cell may take one of several different forms and sizes, as is known in the art.

Mobile appliances 18, each include antenna 19 for wirelessly communicating with other mobile appliances 18. It is appreciated that the antenna 19 may be comprised of multiple antennas tuned for the respective operating frequencies. Each mobile appliance 18 can communicate with fixed communication devices 17 (such as telephone or computer connected to the PSTN or PSDN, an Internet server, etc.) and/or other mobile appliances 18 on network backbone 12 via selected cell site 14. Upon roaming from one cell to another, mobile appliances 18 are configured to associate with a new cell site 14. Mobile appliance 18 registers with a particular cell site 14 to obtain wireless access to network backbone 12. Typically cell sites 14 and mobile appliances 18 in different cells can communicate with each other during the same time period, such that simultaneous communication is occurring in wireless system 10.

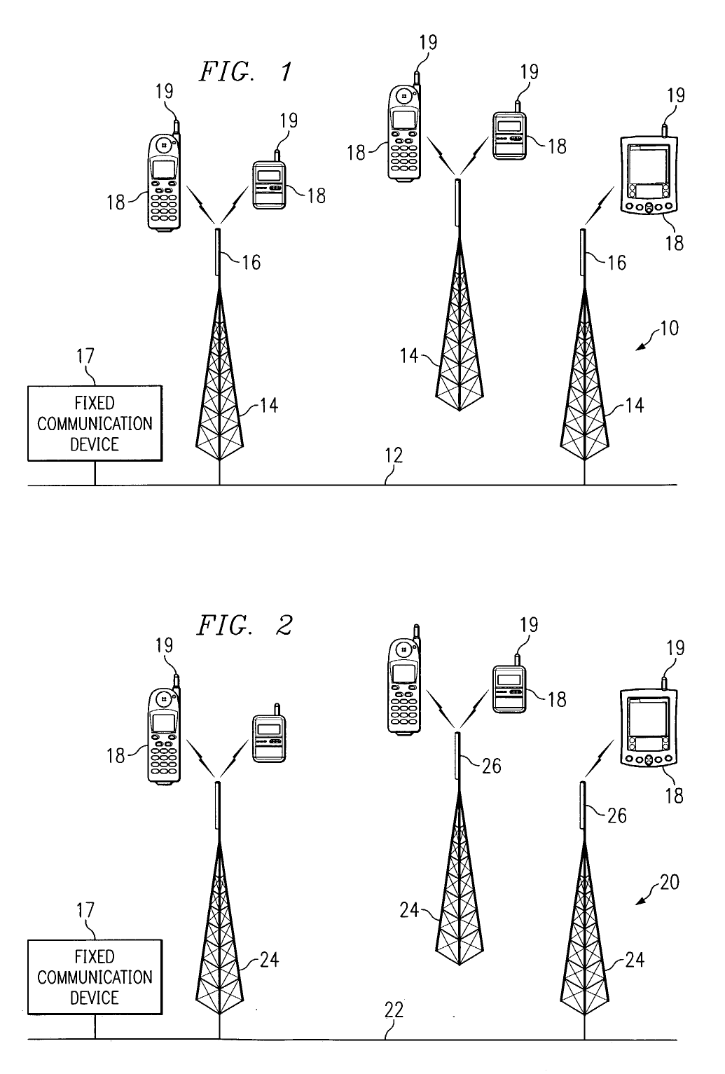

Turning now to FIG. 2, wireless telecommunications network system 20 comprises WLAN 22. WLAN 22 can be a hardwired data communication path made of twisted pair cable, shielded coaxial cable or fiber optic cable, for example, or may be wireless or partially wireless in nature. Coupled to WLAN 22 are one or more fixed communication devices 17 and several WLAN access points 24. Although only two WLAN access points 24 are shown hardwired to WLAN 22, several WLAN access points 24 can be coupled to WLAN 22 via a wired or wireless connection.

Each WLAN access point 24 is capable of communicating wirelessly with mobile appliances 18, such as cell phones, pagers, PDA, email devices (e.g., BLACKBERRY™), etc., in wireless communication system 20 via respective antennas commonly denoted by reference numeral 26. Antenna 26 associated with each WLAN access point 24 can be a fixed directional antenna (such as a 120 degree sector antenna) directed to a particular position or direction, thereby facilitating uni-directional or bi-directional data transmission to a particular mobile appliance 18. A geographic cell (not shown) associated with each WLAN access point 24 defines a region of coverage in which successful wireless communication may occur. Depending on the type of directional antenna 26 selected and output power of the respective WLAN access point 24, the geographic cell may take one of several different forms and sizes.

Wireless system 20 also includes one or more mobile appliances 18. Each mobile appliance 18 communicates with fixed communication devices 17 (such as telephone or computer connected to the PSTN or PSDN, an Internet server, etc.) and/or other mobile appliances 18 on WLAN 22 via selected WLAN access point 24. Preferably, WLAN 22 conforms to the IEEE standard 802.11 “Direct Sequence Spread Spectrum (DSSS) Physical Layer Specification”. Alternatively, WLAN 22 can employ the IEEE standard 802.11 “Frequency Hopping Spread Spectrum (FHSS) Physical Layer Specification” or IEEE standard 802.11a “Othogonal Frequency Division Multiplexing Physical Layer Specification”.

In accordance with an embodiment of the present invention, mobile appliance 18 includes circuitry and/or software to communicate over both WAN based network 10 and WLAN based network 20. WAN based network 10 can be any type of cellular/wireless network, including but not limited to the Global System for Mobile Communications (GSM) network, Code Division Multiple Access (CDMA) network, Time Division Multiple Access (TDMA) network, Personal Communication Services (PCS) network, Wide-Band CDMA (WCDMA) network, 3G networks, etc. It is appreciated that any mobile appliance or wireless communications device, including but not limited to a cell phone, data terminal, PDA, pager, and email device (e.g., BLACKBERRY™), can be used to practice the present invention.

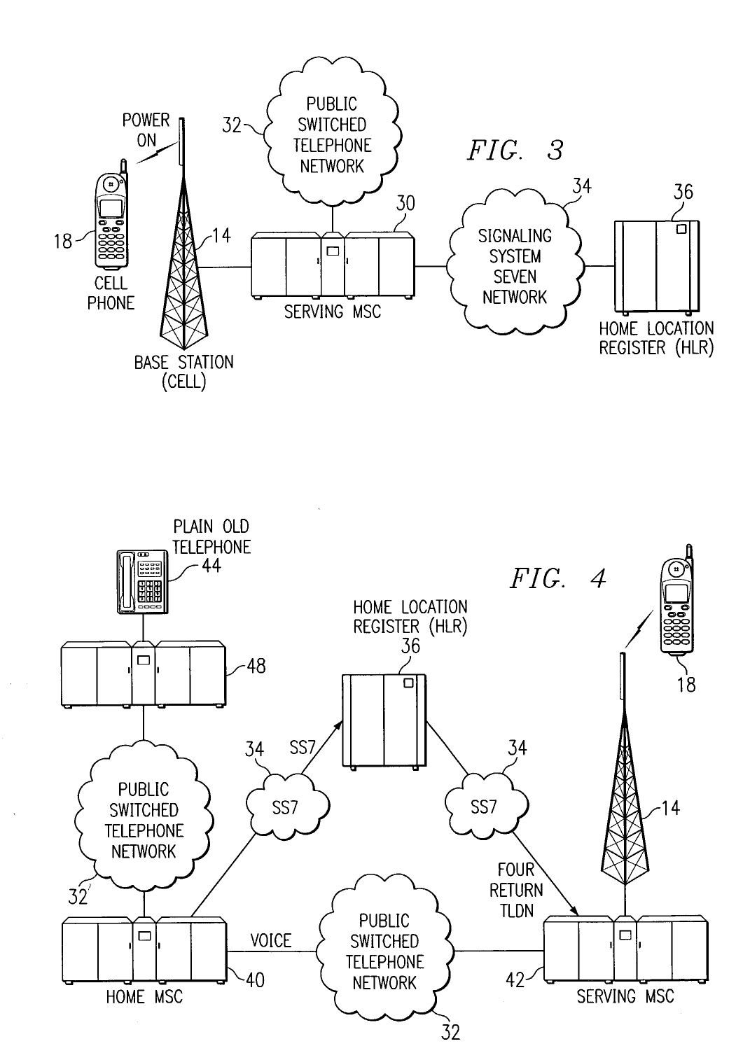

Turning now to FIG. 3, there is illustrated an aspect of the present invention wherein WLAN-enabled mobile appliance 18 is a cell phone. Cell phone 18 operates as a normal cellular phone over WAN based cellular network 10 in FIG. 1. When cell phone 18 is turned on, it sends a data message to the nearest cell site or base station 14. The message generally contains the Mobile Identification Number (MIN) and the Electronic Serial Number (ESN). Cell site 14 forwards the MIN and ESN information to a switch or Mobile Switching Center (MSC) 30, which is generally referred to as the serving mobile switching center. MSC 30 is connected to WAN-based cellular network 10 which can comprise PSTN 32 and Signaling System Seven (SS7) network 34. MSC 30 compares the MIN with a table of all MINs in the WAN-based cellular network and determines which database contains the WAN or cellular user's profile. The database containing the WAN user's profile is generally referred to as Home Location Register (HLR) 36 and the users associated with HLR 36 are generally referred to as the home customers or users. It is appreciated that HLR 36 for home customers can be integrated into the MSC 30 or stored on a separate platform.

MSC 30 sends the data message or registration to HLR 36 over SS7 network 34, notifying HLR 36 that a WAN user or subscriber has requested service from MSC 30. Upon receipt of the registration message from mobile switching center 30, HLR 36 checks the MIN and the ESN contained in the registration message. If the MIN and ESN are determined to be valid, HLR 36 stores the location of cell phone 18 associated with the WAN user and transmits a return message containing the WAN user's profile to MSC 30. The user profile includes information about the user's services (e.g., subscription plan) and features, such as call forwarding, call waiting, 3-way calling, etc.

Upon receipt of the return message from HLR 36, MSC 30 generates a record in its Visitor Location Register (VCR)(not shown) to store the WAN user's profile. Mobile switching center 30 refers to the visitor location register associated with the WAN user as the WAN user makes and/or receives calls on the MSC 30. As the WAN user roams from one cell site to another, cell phone 18 associated with the WAN user deregisters with MSC 30 of the previous cell site and registers with new MSC 30 associated with the new cell site. When HLR 36 receives a notification that the WAN user has moved to a different MSC 30 (i.e., different cell site), HLR 36 sends a message to previously registered mobile switching center 30 to cancel or remove the WAN user's profile from the VLR.

Call delivery occurs when someone places a call to cell phone 18. For example, as shown in FIG. 4, when someone dials the phone number of cell phone 18 from a wired telephone 44 connected to a local exchange switch 48, the call is routed to the WAN user's home MSC 40 over public switched telephone network (PSTN) 32. WAN user's home MSC 40 transmits a query to HLR 36 over SS7 network 34 to determine the current location of cell phone 18. HLR 36 can search its record to determine the current location of cell phone 18. As noted herein, HLR 36 stores the location of cell phone 18 each time cell phone registers with a particular MSC and provides serving MSC 42 with WAN user's profile. HLR transmits a data message over SS7 network 34 to serving mobile switching center 42 requesting a temporary number for routing the call to cell phone 18 registered with MSC 42.

Serving MSC 42 associates a Temporary Local Directory Number (TLDN) with the WAN user and transmits the TLDN to HLR 36 over SS7 network 34. It is appreciated that the TLDN is a regular telephone number that is routable through the PSTN 32. For example, if the WAN user is roaming in New York City, the TLDN is a temporary New York City number. HLR 36 forwards the received TLDN to home mobile switching center 40, which routes the call to serving mobile switching center's TLDN over PSTN 32.

When serving mobile switching center 42 receives a call directed to the TLDN associated with the WAN user, serving mobile switching center 42 delivers the call to cell phone 18 via cell site 14.

In addition to the normal cellular communication, cell phone 18 can communicate over WLAN-based network 20 via WLAN access points 24 employing the IEEE 802.11 standard. Cell phone 1-8 can access, browse or download files from the Internet or transmit/receive email messages over WLAN-based network 20. It is appreciated that WLAN-based network 20 supports higher transmission rates than WAN-based network. The IEEE 802.11b WLAN-based network can support transmission rate of 11 Mbps and IEEE 802.11a WLAN-based network can support transmission rate of 54 Mbps. Whereas, typical WAN-based network can support transmission rates of only 20-50 Kbps. Accordingly, the present invention enables WAN users to use their WLAN enabled mobile appliances to locate nearby WLAN access points 24, thereby enabling the WAN users to access and utilize the higher transmission rates of WLAN-based network 20 to surf the Internet, download video and large data files, etc. After informing the WAN user of nearby WLAN access points, the WAN network provider can use the method and system described in co-pending application entitled “Method and System of Providing Bandwidth on Demand to WAN user form WLAN Access Point”, Ser. No. ______ [attorney docket number 100111016-1], to provide access to WLAN-based network 20 to the WAN user.

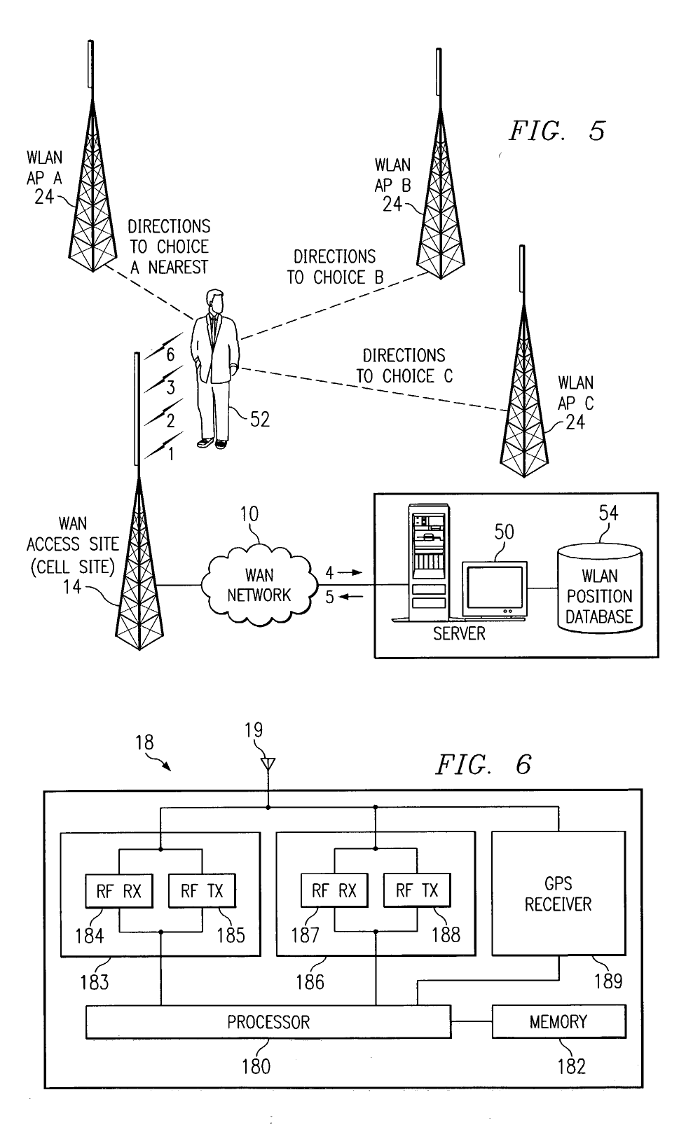

In accordance with an embodiment of the present invention, an example of a method of informing the WAN user of nearby WLAN access points or sites (WLAN-APs) 24 is described in conjunction with FIG. 5. In step 1, WAN user 52 receives a message from the WAN network provider (not shown) that there is an email with attachment. In step 3, the network provider offers WAN user 52 an option of purchasing a service that locates and provides direction to nearby WLAN access points 24, so that WAN user 52 can locate and access higher bandwidth WLAN network 20 (FIG. 2) to quickly download the attachment. In accordance with an aspect of the present invention, the network provider offers a service to WAN user 52 that provides locations and/or directions to one or more nearby WLAN access points 24 based on WAN user's current position, thereby enabling WAN user 52 to access and utilize high speed WLAN network 20. It is appreciated that the network provider can use various known methods and systems to determine the current position of WAN user, such as, but not limited to, the Global Positioning System (GPS), the registration of WAN user 52 with a particular cell site 14 on WAN network 10, automatic location identification associated with enhanced 911 (E911) service advanced by the Federal Communications Commission (FCC), etc.

In accordance with an embodiment of the present invention, steps 1 and 2 can alternatively involve WAN user 52 requesting positions and/or directions to one or more nearby WLAN access points 24. Thereby, enabling WAN user 52 to access high speed WLAN network 20 to send an e-mail with attachment, browse the Internet, download file from a website, etc.

If WAN user 52 elects to utilize the service, then the network provider receives an offer acceptance message from WAN user 52 and determines the current position of WAN user 52 in step 3. Alternatively, WAN user 52 can subscribe to this service in advance so that the network provider can automatically determine the current position of WAN user 52 if there is an email with attachment for WAN user 52.

The network provider transmits the position information of WAN user 52 over WAN network 10 to WAN/WLAN position location server 50 which determines one or more WLAN access points 24 that are accessible from WAN user's current position in step 4. WAN/WLAN position location server 50 searches WLAN position database 54 for WLAN access points 24 that are accessible by WAN user 52 from his/her current position in step 5. Additionally, WAN/WLAN position location server 50 transmits to the network provider the locations and/or directions to these accessible WLAN access points 24 in step 5. Alternatively, the network provider can directly access WLAN position database 54 to retrieve the WLAN-AP location/direction information over WAN network 10. Preferably, the accessible WLAN access points 24 are ordered or prioritized based on their proximity to the WAN user's current position. Although only one WAN/WLAN position location server 50 and only one WLAN position database 54 are shown connected to WAN network 10, several WAN/WLAN position location servers 50 and WLAN position databases 54 can be coupled to WAN network 10 to provide, for example, robustness and redundancy.

In accordance with an embodiment of the present invention, WAN/WLAN position location server 50 transmits to the network provider the location and/or direction to WLAN access points 24 that is nearest to the WAN user's current position. Preferably, WAN/WLAN position location server 50 also transmits to the network provider the locations and/or directions to one or more alternate WLAN access points 24, for example, the second or third nearest access points 24 to the WAN user's current position.

The network operator then sends the received locations and/or directions to one or more accessible WLAN access points 24 to mobile appliance 18 of WAN user 52 in step 6. Also, in step 6, the network operator charges or bills the WAN user account for the use of this service. The network operator can bill WAN user 52 a predetermined amount for each time the service is used.

It is appreciated that a single WLAN/WAN/Position Location-enabled mobile appliance 18 can be employed to communicate with WLAN access points 24 in communication with WLAN network 20 employing the IEEE 802.11 standard and cell sites 14 in communication with WAN network 10. Turning now to FIG. 6, a schematic representation of WLAN/WAN/Position Location-enabled mobile appliance 18 is shown according to one particular aspect of the present invention, wherein a processor 180 is operable to control the general operation of WLAN/WAN/Position Location-enabled mobile appliance 18. The processor 180 is programmable to control and operate the various components within WLAN/WAN/Position Location enabled mobile appliance 18 in order to carry out the various functions described herein and other components (not shown) typically associated with mobile appliance 18, such as a cell phone, a pager, an email device, a PDA and the like. It is appreciated that the processor or CPU 180 can be any known, available processor, microprocessor, micro-controller or other comparable device. The manner in which processor 180 can be programmed to carry out the functions relating to the present invention will be readily apparent to those having ordinary skill in the art.

WLAN/WAN/Position Location-enabled mobile appliance includes memory 182 which is connected to processor 180. Memory 182 stores the program code executed by processor 180 for carrying out operating functions of WLAN/WAN/Position Location enabled mobile appliance 18 as described herein. In accordance with an embodiment of the present invention, WLAN/WAN/Position Location-enabled mobile appliance 18 comprises a first Radio Frequency (RF) module 183 connected to processor 180 for transmitting and receiving data from WLAN access points 24 in communication with WLAN network employing the IEEE 802.11 standard. RF module 183 includes RF receiver 184 and RF transmitter 185. RF receiver 184 is operable to receive RF transmissions from WLAN access points 24 connected to WLAN network 20 via antenna 19 and demodulates the received signal to obtain digital information modulated therein. It is appreciated that the antenna 19 may be comprised of multiple antennas tuned for the respective operating frequencies. RF transmitter 185 is operable to transmit information to WLAN access points 24 connected to WLAN network 20, for example, in response to an operator input at keypad (not shown). WLAN/WAN/Position Location-enabled mobile appliance 18 also comprises a second RF module 186 connected to processor 180 for transmitting and receiving data from cell sites 14 connected to WAN network 10. RF module 186 includes RF receiver 187 and RF transmitter 188. RF receiver 187 is operable to receive RF transmissions from cell sites 14 connected to WAN network 10 via antenna 19 and demodulates the signal to obtain digital information modulated therein. RF transmitter 188 is operable to transmit information to cell sites 14 connected to WAN network 10, for example, in response to an operator input at keypad (not shown) or the receipt of a registration request when WLAN/WAN/Position Location-enabled mobile appliance 18 is turned on.

In accordance with an embodiment of the present invention, WLAN/WAN/Position Location-enabled mobile appliance 18 comprises one RF module 183 to transmit and receive data from both cell sites 14 connected to WLAN network 10 and WLAN access points 24 connected to WLAN network 20. It is appreciated that RF module 183 may include additional circuitry or software to operate RF receiver 184 and RF transmitter 185 in dual-mode, i.e., WAN mode and WLAN mode.

In accordance with an embodiment of the present invention, WLAN/WAN/Position Location-enabled mobile appliance 18 comprises a position location device such as the GPS receiver 189 that is in communication via antenna 19 with a worldwide Middle Earth Orbit (MEO) satellite navigational system, i.e., a GPS system, to determine the current position of WLAN/WAN/Position Location-enabled mobile appliance 18. It is appreciated that the antenna 19 may be comprised of multiple antennas tuned for the respective operating frequencies. Preferably, upon request, WLAN/WAN/Position Location-enabled mobile appliance 18 transmits its current position information to the network provider.

What is claimed is:

1. A method of informing a Wide Area Network (WAN) user of nearby Wireless Local Area Network (WLAN) access points, comprising:
determining a current position of a mobile appliance associated with said WAN user;
transmitting the current position of said mobile appliance to a WAN service provider over a WAN network;
determining the location of one or more WLAN access points that are accessible to said WAN user from the current position of said mobile appliance to provide a WLAN location information; and
transmitting said WLAN location information to said mobile device over said WAN network, thereby enabling said WAN user to locate, access and utilize a WLAN network.

2. The method of claim 1 wherein the step of determining the location of WLAN access points includes:
determining directions to said one or more WLAN access points from the current position of said mobile appliance.

3. The method of claim 1 wherein the step of determining the current position determines the current position of said mobile appliance after receiving a request for nearby WLAN access points from said WAN user.

4. The method of claim 1 wherein the step of determining the current position comprises:
transmitting a message to said mobile appliance that there is an email with attachment for said WAN user along with an offer to provide said WLAN location information to said WAN user over said WAN network; and
determining the current position of said mobile appliance after receiving an offer acceptance message from said mobile appliance over said WAN network.

5. The method of claim 1 wherein the step of determining the location of WLAN access points comprises:
reading a database to determine the location of nearby WLAN access points that are accessible by said WAN user from the current position of said mobile appliance.

6. The method of claim 2 wherein the step of determining the location of WLAN access points includes:
prioritizing the order of said one or more WLAN access points based on WLAN access point's proximity to the current position of said mobile appliance.

7. The method of claim 6 wherein the step of transmitting said WLAN location information transmits the location and directions to a WLAN access point that is nearest to the current position of said mobile appliance.

8. The method of claim 7 wherein the step of transmitting said WLAN location information transmits the location and directions to a WLAN access point that is second nearest to the current position of said mobile appliance.

9. The method of claim 1 wherein the step of determining the current position determines the current position of said mobile appliance either using a global position system or based on registration of said mobile appliance to a cell site of said WAN network.

10. The method of claim 1 wherein the step of transmitting said WLAN location information includes:
billing a predetermined amount to an account of said WAN user.

11. A system for informing a Wide Area Network (WAN) user of nearby Wireless Local Area Network (WLAN) access points, comprising:
a WAN network having a plurality of cell sites and at least one position location server;
a plurality of WLAN access points in communication with a WLAN network;
a mobile appliance associated with said WAN user and in communication with a serving cell site, said serving cell site being one of said plurality of cell sites;
means for determining a current position of said mobile appliance;
wherein said serving site is operable to transmit the current position of said mobile appliance to said position location server over said WAN network; and
wherein said position location server is operable to determine the location of one or more WLAN access points that are accessible to said WAN user from the current position of said mobile appliance to provide a WLAN location information and to transmit said WLAN location information to said mobile device over said WAN network and said serving site, thereby enabling said WAN user to locate, access and utilize said WLAN network.

12. The system of claim 11 wherein said position location server is operable to determine directions to said one or more WLAN access points from the current position of said mobile appliance.

13. The system of claim 11 wherein said mobile appliance transmits a request location information of nearby WLAN access points to a service provider of said WAN network; and wherein said means for determining is operable to determine the current position of said mobile appliance when a service provider of said WAN network receives said request.

14. The system of claim 11 wherein said mobile appliance receives a message that there is an email with attachment for said WAN user and an offer to provide said WLAN location information to said WAN user from a service provider of said WAN network; wherein said mobile appliance is operable to transmit an offer acceptance message to request said WLAN location information to said service provider; and wherein said means for determining is operable to determine the current position of said mobile appliance when said service provider receives said offer acceptance message.

15. The system of claim 11 further comprising a database connected to said position location server; and wherein said position location server is operable to search said database to determine the location of one or more WLAN access points that are accessible to said WAN user from the current position of said mobile appliance.

16. The system of claim 12 wherein said position location server is operable to transmit the location and directions to a WLAN access point that is nearest to the current position of said mobile appliance and the location and directions to another WLAN access point accessible by said WAN user.

17. The system of claim 12 wherein said means of determining is operable to determine the current position of said mobile appliance either using a global position system or based on registration of said mobile appliance to a cell site of said WAN network.

18. The system of claim 11 wherein said mobile appliance is one of the following: a cell phone, an email device, a PDA, a data terminal or a pager.

19. The system of claim 11 wherein said mobile appliance is WLAN enabled to communicate with both said cell sites and said WLAN access points.

20. The system of claim 19 wherein said mobile appliance is operable to transmit and receive data from both cell sites and said WLAN access points.
